(19) United States
(12) Patent Application Publication
(10) Pub. No.: US 2006/0081552 A1
(43) Pub. Date: Apr. 20, 2006

(54) Switch cap for drinking bottle

(76) Inventor: Yi Xin Jiang, Dong Guang City (CN)

Correspondence Address: GLOBAL IP SERVICES, 2462 ROCK ST., APT. 6, MOUNTAIN VIEW, CA, 94043, US

(21) Appl. No.: 11/247,781

(22) Filed: Oct. 11, 2005

(30) Foreign Application Priority Data
Oct. 8, 2004 (CN) 2004100517283

(51) Int. Cl. A61J 11/00; A61J 9/00; A61J 9/04; A61J 9/08; A61J 11/02

(52) U.S. Cl. 215/11.1; 215/11.4; 215/11.5; 215/11.6

(57) ABSTRACT

A switch cap for drinking bottle of the invention includes a rotatable cap; a sucker received inside the rotatable cap; a cap cover covering the rotatable cap; and a switch portion; wherein the rotatable cap is rotatably connected with a circled round mouth the drinking bottle by the switch portion.

### CROSS REFERENCE TO RELATED APPLICATION

This application claims the benefit of a Chinese patent application Filing No.: CN2004100517283, filed on Oct. 8, 2004.

### FIELD OF THE INVENTION

The present invention relates to a switch cap for drinking bottle which can trans-connect with drinking bottle of different caliber, more particularly to that can connect turncap with sucker or sucker to drinking or mineral-water bottle.

### BACKGROUND OF THE INVENTION

At present, there are no switch caps for drinking bottle so as to switch the drinking bottle mouth formerly unsuitable for baby, adult to a suitable sucker for them.

Hence, it is desired to provide a switch cap for drinking bottle to solve the above-mentioned problem.

### SUMMARY OF THE INVENTION

To overcome the above drawbacks of prior art, a main object of the present invention is to provide a switch cap for drinking bottle which can switch an unsuitable mouth of the drinking bottle formerly for people's drinking to a suitable sucker for drinking.

To attain the above object, a switch cap for drinking bottle, of the present invention comprises a rotatable cap; a sucker received inside the rotatable cap; a cap cover covering the rotatable cap; and a switch portion; wherein the rotatable cap is rotatably connected with a circled round mouth the drinking bottle by the switch portion. In the present invention, the switch portion comprises a cap body, an inner screw thread provided on an inner wall of the cap body; an outside screw thread provided on an outer wall of the cap body; and a plurality of slippery-proof concave grooves provided on the outside circle of bottom of the cap body; the cap body has a top portion, a bottom portion which has a larger diameter than the top portion, and a plat shoulder formed in the middle thereof.

In a first embodiment, the relatable cap comprises an annular wall arranged on a top thereof, and an inner cap screw thread formed corresponding to the outside screw thread and engaged with the outside screw thread; the annular wall extends toward its center and is provided for receiving and positioning the sucker. In another embodiment, the rotatable cap comprises a cap body, an annular wall arranged on a top thereof; an inner cap screw thread formed corresponding to the outside screw thread and engaged with the outside screw thread; a lock means on a side of the cap body, and a non-close protrusion on a top end of the cap body; the annular wall extends toward its center and is provided for receiving and positioning the sucker.

In an embodiment, a hinge means is formed on the bottom of the cap cover, which comprises two symmetrical suspension arms in its two ends and a rotation shaft disposed between and integrally formed with the two suspension arms. The lock means of the cap body comprises a detaining groove in the middle thereof for detaining the rotation shaft; and when the rotation shaft is detained in the detaining groove, the suspension arms of the hinge means will just be locked on the two sides of the lock means; the non-close protrusion extends upwardly along an outer edge of the annular wall. The sucker comprises a sucking part concave inwardly from a head of the sucker, and a positioning pipe; the positioning pipe comprises a drinking straw extending downwardly from a bottom of the sucker. In an embodiment, a ventilate groove is provided on a hemisphere bottom of the sucker.

Comparing to the prior art, the switch cap of the present invention can switch a mouth of a drinking bottle formerly unsuitable for drinking to a suitable sucker for drinking. The design of the switch cap thereby enlarges an application scope of various drinking bottle and is suitable for people of various age. In addition, the switch cap is made of harmless and nonpoisonous materials up to the standards of FDA of USA and EN71 of EU. Furthermore, a design for human makes the switch cap of the present invention safe, sanitary, leak proof, reasonable, convenient for taking and washing and can be used repeatedly.

For the purpose of making the invention easier to understand, several particular embodiments thereof will now be described with reference to the appended drawings.

### DESCRIPTION OF THE DRAWINGS

FIG. 1 is an assembly view of a switch cap for drinking bottle of the invention;

FIG. 2 is a schematic view of a switch portion of the switch cap according to a first embodiment of the invention;

FIG. 3 is a partial, cross-sectional view of the switch portion of FIG. 2;

FIG. 4 is a schematic view of a switch portion of the switch cap according to a second embodiment of the invention;

FIG. 5 is a partial, cross-sectional view of the switch portion of FIG. 4;

FIG. 6 is a schematic view of a drinking bottle of the invention;

FIG. 7 is a perspective view of a switch portion of the invention;

FIG. 8 is a cross-sectional view of the switch portion of FIG. 7;

FIG. 9 is a perspective view of a rotatable cap according to a first embodiment of the invention;

FIG. 10 is a perspective view of the rotatable cap of FIG. 9 according to another angle of view;

FIG. 11 is a perspective view of a sucker of the switch cap according to a first embodiment of the invention;

FIG. 12 is a perspective view of the sucker in FIG. 11 according to another angle of view;

FIG. 13 is a schematic view of a cap cover of the switch cap according to a first embodiment of the invention;

FIG. 14 is a perspective view of a rotatable cap according to a second embodiment of the invention;

FIG. 15 is a perspective view of the rotatable cap in FIG. 14 according to another angle of view;

FIG. 16 is a perspective view of a cap cover of the switch cap according to a second embodiment of the invention;

FIG. 17 is a perspective view of a sucker of the switch cap according to a second embodiment of the invention.

FIG. 18 is a schematic view of a sucker of FIG. 17 having a straw connected thereon.

### DETAILED DESCRIPTION OF THE INVENTION

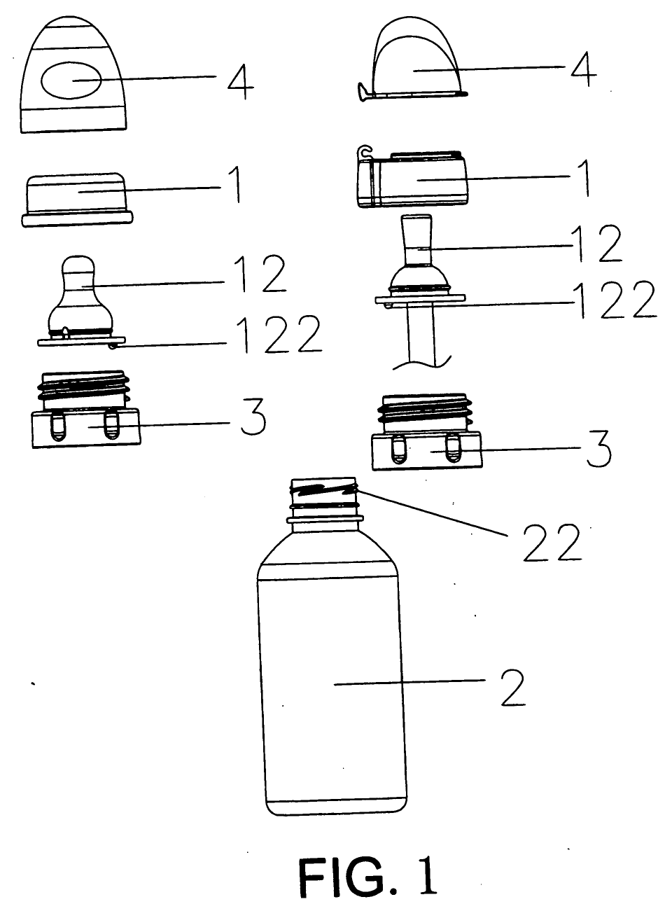

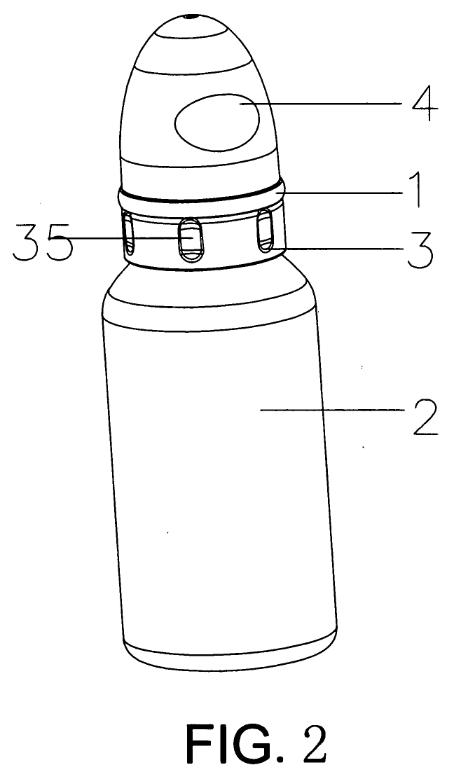

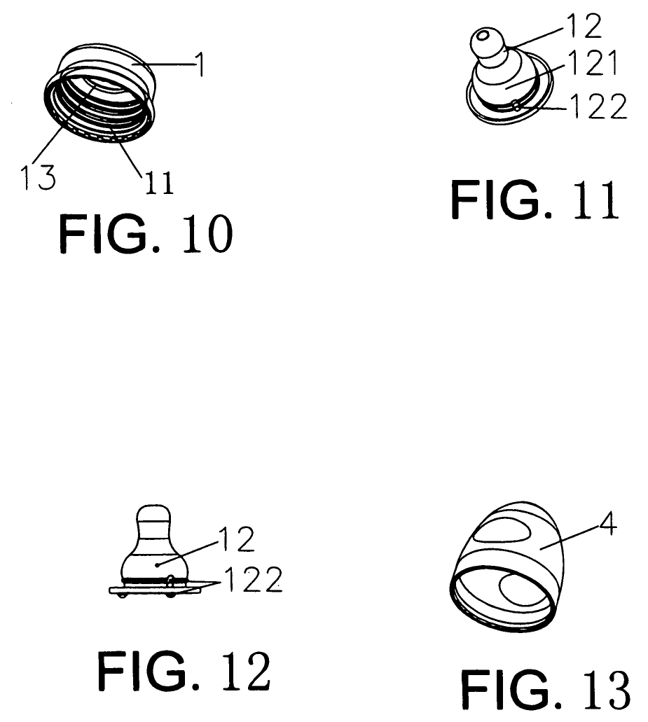

Referring to the drawings in detail, FIGS. 1-3, 6-13 show a switch cap for drinking bottle according to a first embodiment of the invention. The switch cap for drinking bottle comprises a rotatable cap 1, a sucker 12 received inside the rotatable cap 1, a cap cover 4 covering the rotatable cap 1, and a switch portion 3. The rotatable cap 1 is rotatably connected with a circled head portion 21 of a drinking bottle 2 by the switch portion 3. The switch portion 3 comprises a cap body 32, an inner screw thread 33 provided on an inner wall of the cap body 32; an outside screw thread 34 provided on an outer wall of the cap body 32; and a plurality of slippery-proof concave grooves 35 provided on the outside circle of bottom of the cap body 32. In the invention, the switch cap is made of harmless and nonpoisonous materials.

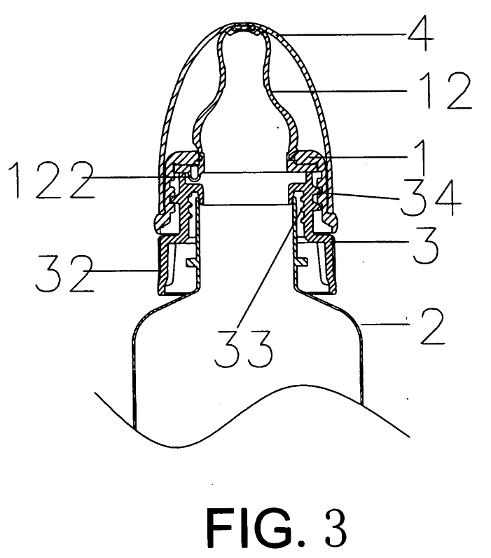

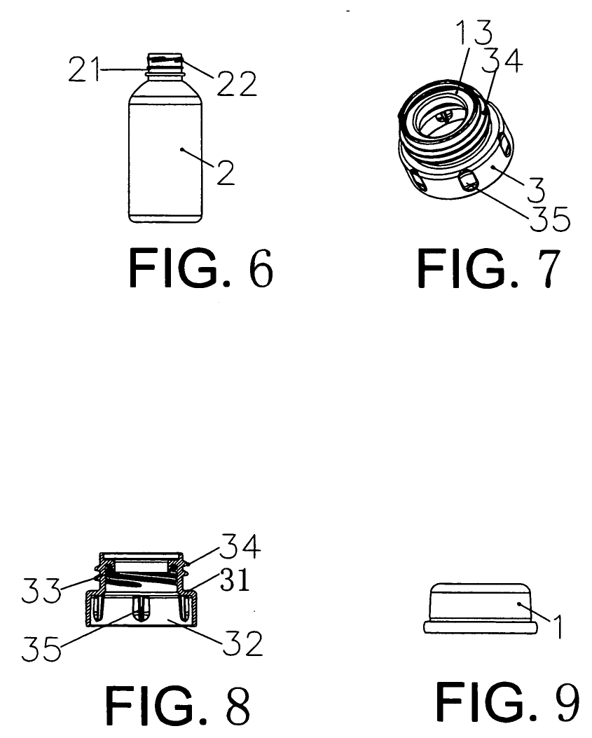

Referring to FIG. 8, the cap body 32 has a top portion, a bottom portion which has a larger diameter than the top portion, and a plat shoulder 31 formed in the middle. Referring to FIG. 6, the drinking bottle 2 comprises an outside bottle screw thread 22 formed on the head portion 21 thereof. Referring to FIGS. 1 and 3, the outside bottle screw thread 22 is engaged with the inner screw thread 33. Referring to FIGS. 8-12, the rotatable cap 1 comprises an annular wall 13 arranged on a top thereof, and an inner cap screw thread 11 formed corresponding to the outside screw thread 34 and engaged with the outside screw thread 34. The annular wall 13 extends toward its center and is provided for receiving and positioning the sucker 12. Referring to FIGS. 11-12, a ventilate groove 122 is provided on a hemisphere bottom 121 of the sucker 12.

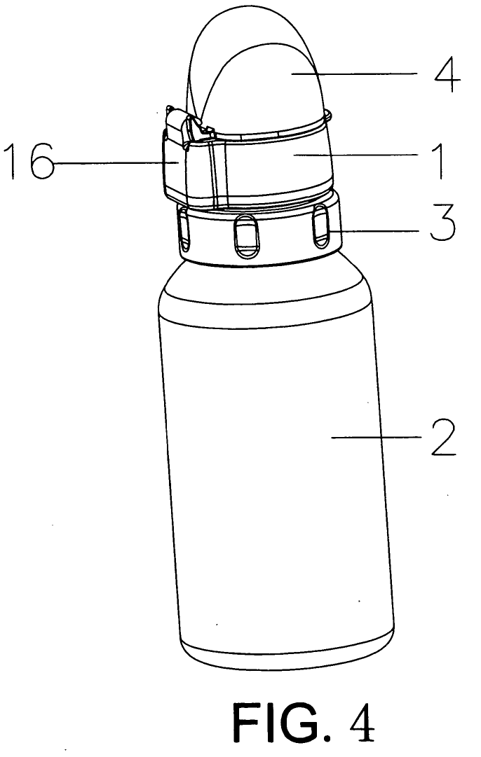

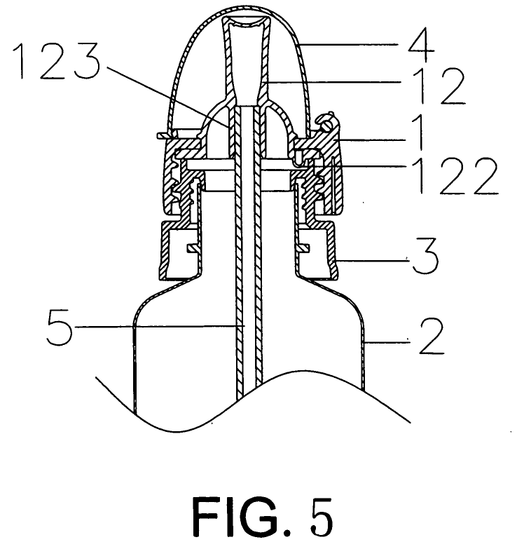

Referring to FIGS. 1, 4-8, 14-18, a switch cap for drinking bottle according to a second embodiment of the invention is illustrated as follows. The switch cap for drinking bottle comprises a rotatable cap 1, a sucker 12 received inside the rotatable cap 1, a cap cover 4 covering the rotatable cap 1, and a switch portion 3. The rotatable cap 1 is rotatably connected with a circled head portion 21 of a drinking bottle 2 by the switch portion 3. The switch portion 3 comprises a cap body 32, an inner screw thread 33 provided on an inner wall of the cap body 32; an outside screw thread 34 provided on an outer wall of the cap body 32; and a plurality of slippery-proof concave grooves 35 provided on the outside circle of bottom of the cap body 32.

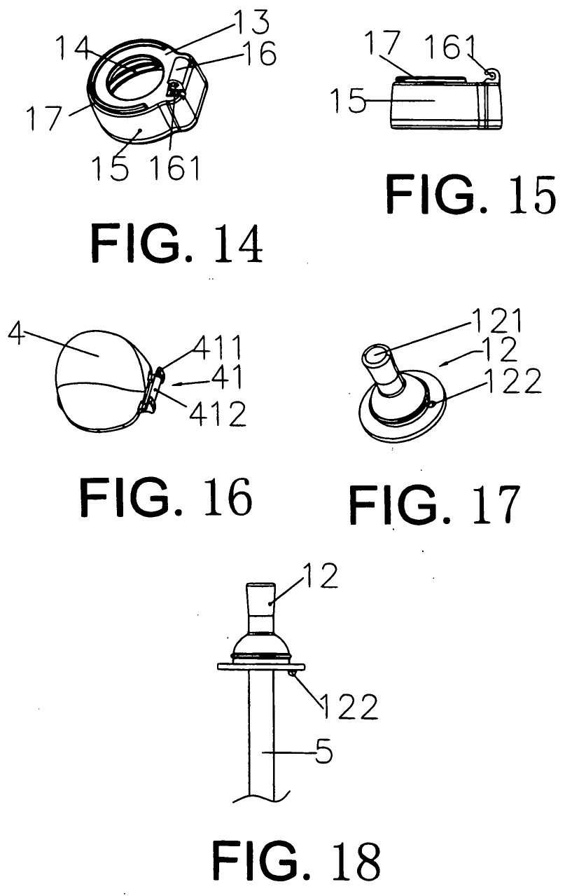

Referring to FIG. 8, the cap body 32 has a top portion, a bottom portion which has a larger diameter than the top portion, and a plat shoulder 31 formed in the middle. Referring to FIG. 6, the drinking bottle 2 comprises an outside bottle screw thread 22 formed on the head portion 21 thereof. Referring to FIGS. 1 and 8, the outside bottle screw thread 22 is engaged with the inner screw thread 33. Referring to FIGS. 7, 10, 14, the rotatable cap 1 comprises a cap body 15, an annular wall 13 arranged on a top thereof; an inner cap screw thread 14 formed corresponding to the outside screw thread 34 and engaged with the outside screw thread 34; a lock means 16 on a side of the cap body 15, and a non-close protrusion 17 on a top end of the cap body 15. Referring to FIGS. 14 and 17, the annular wall 13 extends toward its center and is provided for receiving and positioning the sucker 12. Referring to FIG. 16, a hinge means 41 is formed on the bottom of the cap cover 4, which comprises two symmetrical suspension arms 411 in its two ends and a rotation shaft 412 disposed between and integrally formed with the two suspension arms 411.

Referring to FIGS. 14-16, the lock means 16 of the cap body 15 comprises a detaining groove 161 in the middle thereof for detaining the rotation shaft 412. When the rotation shaft 412 is detained in the detaining groove 161, the suspension arms 411 of the hinge means 41 will just be locked on the two sides of the lock means 16. In fact, the lock means 16 is formed corresponding to the hinge means 41 of the cap cover 4 and engaged therewith. Referring to FIG. 14, the non-close protrusion 17 extends upwardly along an outer edge of the annular wall 13.

Referring to FIG. 18, the sucker 12 comprises a sucking part 124 concave inwardly from a head of the sucker 12, and a positioning pipe 123. The positioning pipe 123 comprises a drinking straw 5 extending downwardly from the hemisphere bottom 121 of the sucker 12. Also, a ventilate groove 122 is provided on a hemisphere bottom 121 of the sucker 12.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A switch cap for drinking bottle, comprising:
a rotatable cap;
a sucker received inside the rotatable cap;
a cap cover covering the rotatable cap; and
a switch portion, wherein the rotatable cap is rotatably connected with a circled round mouth the drinking bottle by the switch portion.

2. The switch cap as claimed in claim 1, wherein the switch portion comprises a cap body, an inner screw thread provided on an inner wall of the cap body; an outside screw thread provided on an outer wall of the cap body; and a plurality of slippery-proof concave grooves provided on the outside circle of bottom of the cap body; the cap body has a top portion, a bottom portion which has a larger diameter than the top portion, and a plat shoulder formed in the middle thereof.

3. The switch cap as claimed in claim 1, wherein the rotatable cap comprises an annular wall arranged on a top thereof, and an inner cap screw thread formed corresponding to the outside screw thread and engaged with the outside screw thread; the annular wall extends toward its center and is provided for receiving and positioning the sucker.

4. The switch cap as claimed in claim 1, wherein the rotatable cap comprises a cap body, an annular wall arranged on a top thereof; an inner cap screw thread formed corresponding to the outside screw thread and engaged with the outside screw thread; a lock means on a side of the cap body, and a non-close protrusion on a top end of the cap body; the annular wall extends toward its center and is provided for receiving and positioning the sucker.

5. The switch cap as claimed in claim 4, wherein a hinge means is formed on the bottom of the cap cover, which comprises two symmetrical suspension arms in its two ends and a rotation shaft disposed between and integrally formed with the two suspension arms.

6. The switch cap as claimed in claim 5, wherein the lock means of the cap body comprises a detaining groove in the middle thereof for detaining the rotation shaft; and when the rotation shaft is detained in the detaining groove, the suspension arms of the hinge means will just be locked on the two sides of the lock means; the non-close protrusion extends upwardly along an outer edge of the annular wall.

7. The switch cap as claimed in claim 1, wherein the sucker comprises a sucking part concave inwardly from a head of the sucker, and a positioning pipe; the positioning pipe comprises a drinking straw extending downwardly from a bottom of the sucker.

8. The switch cap as claimed in claim 1, wherein a ventilate groove is provided on a hemisphere bottom of the sucker.
